(19) United States
(12) Patent Application Publication
(10) Pub. No.: US 2009/0192901 A1
(43) Pub. Date: Jul. 30, 2009

(54) Calorie counting POS system

(76) Inventor: Zoltan Egeresi, Santa Cruz, CA (US)

Correspondence Address: ZOLTAN EGERESI, 5500 COAST Rd., SANTA CRUZ, CA, 95060, US

(21) Appl. No.: 12/011,710

(22) Filed: Jan. 30, 2008

(51) Int. Cl. G06Q 50/00

(52) U.S. Cl. 705/15

(57) ABSTRACT

The Calorie Counting POS System is a software value addition to current POS systems with price look-ups. Food item entry generates a parallel look up into the Calorie Data Register (Calorie Data Table), subroutine ads all calorie entries, ads total calorie count of the order, displays it and prints it with regular information such as total price, taxes, method of payment. This printed information gives a valuable record to the customer of total consumed calories.

### CROSS REFERENCE RELATED APPLICATIONS

Did not find any cross references or prior arts where a POS, Point of Sales Terminal actually adds and totals all calories of purchased food consumed or taken out in restaurants or fast food outlets.

Several calorie calculators exist where the user is required to add all data based on portion size, type of food, weight of food, size of liquid consumed. Measured against weight of person, recommended calorie intake per day, deducting calories used during exercise and other calorie related activities may modify the calorie count. POS Point of sales Systems are under category 705/24, 705/18.

### FEDERALLY SPONSORED RESEARCH AND DEVELOPMENT

Not applicable

### BACKGROUND OF THE INVENTION

### Field of the Invention

This invention relates to counting calories in restaurants, fast food service places where the customer or the establishment is interested to state the individual calorie value of the items. By displaying and printing the total food order with calorie totals customers can monitor their calorie intake. Over weight customers and lawyers constantly looking for ways to blame and hold others liable for some one else's short comings. This calorie counting POS system makes it easier for any food establishment to count and print all consumed or taken out food items' total calorie value, so customers can be properly informed. Calorie intake requirements or limitations are based on individuals weight, physical condition, length or type of exercising on a daily bases and some other factors. Current calorie monitors are hand held calculators or PC based software where the user needs to know the actual calorie value of any consumed food, add it into the system as it is designed to monitor calorie intake from many different sources. This type of health/calorie monitoring systems looks at gender, height, type and length of exercise etc. to balance daily calorie intake versus calorie burning activities for weight control. My invention is only interested in tracking calorie of purchased food ordered from a a restaurant or from any fast food or similar establishments.

### BRIEF SUMMERY OF THE INVENTION

The object of this invention is to create a novel way to monitor calorie intake in restaurants and fast food establishments tracking it on the Point of sales System. POS systems in restaurants or fast food establishments in most cases contain only the description of items, the price and taxability. In the Calorie Counting POS system the calorie value is added to the item description line without affecting any sales totals. The Calorie Counting POS contains a new addressable memory table, an actual separate Calorie Look-Up table/Calorie Data Register corresponding to the food items as listed in the price look up table.

When items are selected, the corresponding calorie values are selected, pointer looks at the corresponding look up table, takes the calorie value, counter provides addition or extension for multiple entry and totaled as a Calorie Total.

When the transaction is finalized payment is tendered, than all registers are reset for the for the next entry.

The objection of my invention is tracking calories of purchased food items from the establishment. It is extremely time consuming and it is a cumbersome task to add and track all consumed food items since many of the same food comes with different sizes, adding some extra ingredients calorie count increases. In fast food eateries posting all food to go items with different variations would require big boards to be visible and readable by the customers, than places the burden on the customer to add all calories. Restaurants know the calorie totals of all orders, drinks, deserts etc. that can be printed out for the customers as a healthy advise how much calorie was consumed.

### BRIEF DESCRIPTION OF THE INVENTION

The Calorie Counting POS System is a software value addition to current POS systems with price look-ups. Food item entry generates a parallel look up into the Calorie Data Table, subroutine adds all calorie entries, extends entry if required, adds total calorie count of the order, displays it and prints it with regular information such as total price, taxes, method of payment etc. This printed information gives a valuable record to the customer of total consumed calories.

### BRIEF DESCRIPTION OF SEVERAL VIEWS OF THE DRAWINGS

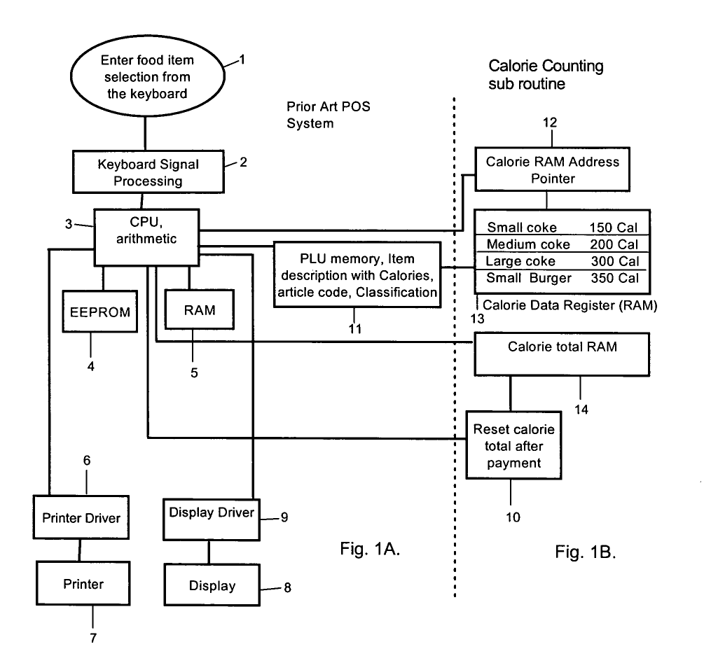

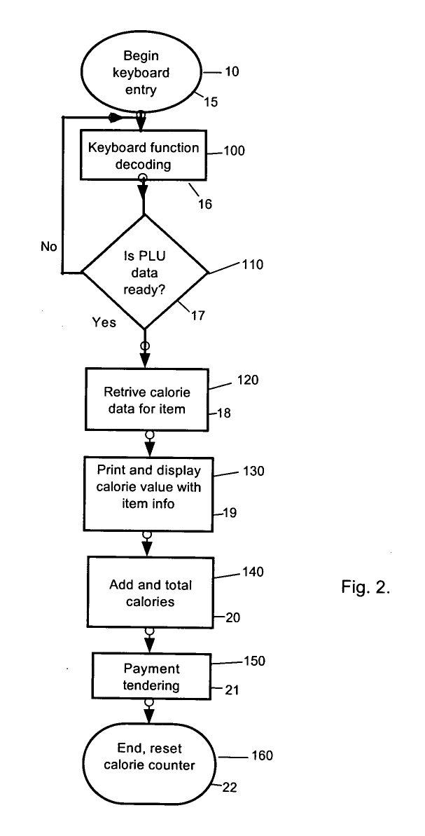

Two pages are presented, a block diagram for the Calorie Counting POS System on sheet 1 FIGS. 1A and 1B and the flow chart on sheet 2 is FIG. 2.

### DETAILED DESCRIPTION OF THE INVENTION

This is an example how a printed ticked with calorie count looks like. Sub routine can vary, as it can be adapted to many different POS systems.

Order No 122

HamBurger Palace

Santa Cruz, Calif. 95060

Jan. 25, 2008

Cashier: Maria

| Item | Qty | Description | Subtotal | Calorie total |
|---|---|---|---|---|
| 1 | 1 | Small burger | $2.50 | 250 |
| 2 | 2 | Cheese burger | 6.50 | 600 |
| | | 2 @ $3.25 | | |
| 3 | 1 | Medium coke | 1.25 | 100 |
| 4 | 1 | Large apple pie | 3.50 | 325 |

| | | |
|---|---|---|
| Sub Total | $12.75 | 1,275 |
| Tax | .65 | |
| Total | 13.40 | 1,275 |
| Payment cash | 15.00 | |
| Change | $1.60 | |

We hope you enjoyed our food, your total order was 1,275 calories. This information is to help you monitor your daily calorie intake.

Order No 129

Kentucky Chicken Palace

Santa Cruz, Calif. 95060

Jan. 25 2008

Cashier: Maria

| Item | Qty | Description | Subtotal |
|---|---|---|---|
| 1 | 1 | Chicken brst. 550 cals. | $2.50 |
| 2 | 1 | Sml. slaw 75 cals. | 1.25 |
| 3 | 1 | Medium coke 100 cals. | 1.25 |
| 4 | 1 | Apple pie, 325 cals. | 2.50 |

| | |
|---|---|
| Sub Total | $7.50 |
| Tax | .53 |
| Total | 8.03 |
| Payment cash | 10.00 |
| Change | 1.97 |

We hope you enjoyed our food, your total order was 1,050 calories.

This example of the ticket printing shows the calorie value on the same line as the food item entry. Positioning of calorie data can change according to display and POS printers being used. The block diagram is on sheet 1 of 2.

Practically all current prior art POS Point Of Sales systems are stand alone PC based or terminal driven by a host computer. FIG. 1A on sheet one is typical POS system with a PLU configuration, FIG. 1B is the novelty addition to current systems, the Calorie Counter POS system.

When keyboard (1,2) is configured for fast food entry in prior arts, as an item is selected a PLU Price Look Up signal is being generated, the CPU (3) addresses the PLU(11) table for the selected item, requested information is retrieved from the memory, description, unit price, article code, CPU performs arithmetic operation for multi item entry additions and tax calculations.

This data is added to the sub total register (5), if taxable tax is calculated, than data moves to the printer driver (6) and to printer (7) for hard copy same data to display driver (9) and display (8). Functions of amount tendering, cash drawer activations, X and Z totals or any other options are not illustrated. EEPROM (4) is used to boot up the computer.

As a novelty, this invention adds additional description to the item entry information the actual calorie value of the selected food item. This could be part of the current PLU description line (11) indicating eg. Chicken breast 500 cals. $2.50. For payment purposes only the $ value 2.50 gets added to the sub total, item descriptions stays on the display (8) or gets printed (7). The same PLU code initiates a CDR (Calorie Data Register) access to fetch the calorie value of the selected item from the Calorie Data Register RAM (13). The calorie value is stored entirely in the CDR RAM (13) and it is optional if printing and displaying is on the same line.

For multiple entry, CPU (3) calculates the total calories and moves the result to the Calorie Total RAM (14). This cycle gets repeated for all entries until sales are totaled, payment is tendered, than calorie total RAM (14) gets a reset signal from the CPU (3). Calorie total is displayed and printed to the customer for accurate calorie count. Sheet 2 of 2 FIG. 2 shows the flow chart of the calorie Counting POS System.

Operation starts with the Keyboard entry (15), data may be of bar code origin, data passes trough the CPU, than PLU data request is initiated, item description with calorie value is PLU data ready (17), if yes, retrieved calorie data (18) is displayed and printed (19), calorie totals are accumulated in Calorie Total RAM(20), end of cycle at payment tendering (21) generates a calorie total reset (22).

What is claimed is:

1. A calorie calculating POS System comprising:
a keyboard or bar code reader for data entry as means for manually entering the purchased food item containing the description of food with calorie value;
the POS calorie calculator further comprising of an address pointer for directing to the address of said memory and retrieving the data containing the calorie value of the selected food item;
said keyboard entry generates displayed and printed data output with calorie values and sub totals or extended subtotals for multiple entry corresponding to selected food items;
total calorie count is stored in a Calorie Total Memory, displayed and printed out to the customer to advise him or her of the total calorie consumption as per order.
